(19) United States
(12) Patent Application Publication
(10) Pub. No.: US 2010/0276057 A1
(43) Pub. Date: Nov. 4, 2010

(54) ETHYLENE-BUTENE COPOLYMER, ADHESIVE COMPOSITION INCLUDING THE SAME, AND METHOD OF MAKING AND USING THE SAME

(75) Inventors: Steven W. Albrecht, Forest Lake, MN (US); Michelle C. Kueppers, North Oaks, MN (US); Stephen M. Willging, Minneapolis, MN (US); Timothy W. Roska, Forest Lake, MN (US); Vitaly Rogachevsky, Woodbuty, MN (US)

Correspondence Address: H.B. FULLER COMPANY;Patent Department, 1200 WILLOW LAKE BLVD., P.O. BOX 64683, ST. PAUL, MN, 55164-0683, US

(73) Assignee: H.B. Fuller Company, St. Paul, MN (US)

(21) Appl. No.: 12/766,687

(22) Filed: Apr. 23, 2010

Related U.S. Application Data
(60) Provisional application No. 61/174,179, filed on Apr. 30, 2009.

(51) Int. Cl. B29C 65/52; C08L 23/20

(52) U.S. Cl. 156/60; 524/579

(57) ABSTRACT

An ethylene-butene copolymer prepared from ethylene monomer and butene monomer, the ethylene-butene copolymer including at least 78 mole % ethylene and no greater than 22 mole % butene, and a hot melt adhesive composition including from 40% by weight to 90% by weight of the ethylene-butene copolymer, tackifying agent, and wax.

### CROSS-REFERENCE TO RELATED APPLICATIONS

This application claims the benefit of U.S. Provisional Application No. 61/174,179, filed on Apr. 30, 2009, which is hereby incorporated herein.

### BACKGROUND

The invention is directed to forming ethylene-butene copolymers and adhesive compositions including the same.

Hot melt adhesives are used in a variety of applications in the packaging industry including, e.g., case and carton sealing, tray forming and box forming. Typical substrates used in packaging applications include virgin and recycled kraft, high and low density kraft, chipboard and various types of treated and coated kraft and chipboard. Many packaging applications require the hot melt adhesive to exhibit a sufficient degree of adhesion to the substrate to firmly hold the resulting package together, and many packaging applications also require the formation of full fiber tearing bonds.

In addition to good bond performance, many packaging applications also require the hot melt adhesive to exhibit good thermal stability, i.e., the hot melt adhesive does not darken in the glue pot with prolonged exposure to high temperatures, does not produce char, skin or gel, and does not exhibit a substantial viscosity change over time.

Hot melt adhesive compositions that are used in the packaging industry are often based on polymers such as polyethylene, ethylene-vinyl acetate and interpolymers. Many polyethylene-based hot melt adhesives do not exhibit sufficient performance properties on a wide variety of substrates. Ethylene vinyl acetate-based hot melt adhesive compositions often exhibit poor thermal stability.

Low molecular weight polymers are difficult to process and often exhibit cold flow. Low molecular weight polymers also often lack the cohesive strength necessary to form and maintain the bond strengths required in packaging applications.

There is a need for a hot melt adhesive composition that is suitable for a variety of packaging applications and that exhibits good thermal stability.

### SUMMARY

In one aspect, the invention features a hot melt adhesive composition that includes ethylene-butene copolymer prepared from ethylene monomer and butene monomer, the ethylene-butene copolymer having a polydispersity index of from 2 to 6 and including at least 78 mole % ethylene and no greater than 22 mole % butene. In one embodiment, the hot melt adhesive composition includes from 40% by weight to 90% by weight of an ethylene-butene copolymer disclosed herein, from 5% by weight to 30% by weight tackifying agent, from 0% by weight to 20% by weight wax, and from 0% by weight to 5% by weight antioxidant. In another embodiment, the adhesive composition exhibits a fiber tearing bond when tested according to the Fiber Tear test method. In some embodiments, the ethylene-butene copolymer is prepared in the absence of a single site metallocene catalyst.

In another aspect, the invention features a method of bonding a first substrate to a second substrate, the method including applying a hot melt adhesive composition disclosed herein, having a temperature no greater than 120° C., to the first substrate, and contacting the applied hot melt adhesive composition with a second substrate. In one embodiment, at least one of the first substrate and the second substrate includes cellulose fiber.

In other aspects, the invention features a method of making an adhesive composition, the method including preparing an ethylene-butene copolymer having a polydispersity index of from 2 to 6 and including at least 78 mole % ethylene, and no greater than 22 mole % butene, transferring the copolymer to a mixer, and combining at least one of tackifying agent, wax, and antioxidant with the copolymer. In some embodiments, the method further includes forming the adhesive composition, the forming including at least one of pelletizing, pillowing, stranding, and pastillating. In other embodiments, the ethylene-copolymer is in the form of a liquid during transfer to the mixer.

In one embodiment, the method of making an adhesive composition includes transferring an ethylene-butene copolymer in the form of a liquid to a mixer, the ethylene-butene copolymer having a polydispersity index of from 2 to 6 and including at least 78 mole % ethylene, and no greater than 22 mole % butene, and combining at least one of tackifying agent, wax, and antioxidant with the copolymer.

In another aspect, the invention features a method of making an ethylene-butene copolymer, the method including polymerizing ethylene monomer and butene monomer to form an ethylene-butene copolymer having a polydispersity index of from 2 to 6 and including at least 78 mole % ethylene and no greater than 22 mole % butene. In one embodiment, the polymerizing occurs in a reaction zone having a temperature of from about 120° C. to about 355° C. and a pressure of from about 110 MPa to about 350 MPa. In some embodiments, the polymerizing occurs in the presence of a peroxide catalyst. In other embodiments, the polymerizing occurs in the absence of a single site metallocene catalyst.

The hot melt adhesive composition exhibits good adhesion and good bonding performance over a relatively wide temperature range.

The ethylene-butene copolymer exhibits good thermal stability and compatibility in a variety of adhesive compositions.

Other features and advantages will be apparent from the following description of the preferred embodiments and from the claims.

### DETAILED DESCRIPTION

The hot melt adhesive composition includes ethylene-butene copolymer, tackifying agent, wax and optionally antioxidant. The hot melt adhesive composition has a viscosity of less than 20,000 centipoise (cps), less than 10,000 cps, or even less than about 5,000 cps at 350° F. (177° C.). The hot melt adhesive can be applied at a temperature of less than 350° F. (177° C.) or even from about 135° C. to about 177° C.

The hot melt adhesive composition provides sufficient adhesion to hold two substrates together, more preferably the hot melt adhesive composition exhibits a full fiber tearing bond to a fibrous substrate. The adhesive composition exhibits fiber tear, preferably 100% fiber tear, in the bond area preferably at −40° F., −20° F., 0° F., 20° F., 40° F., 77° F., 120° F., 130° F., 140° F., or even 150° F. when tested according to the Fiber Tear test method.

The hot melt adhesive composition preferably is thermal stable such that it does not darken when maintained in a glue pot and subjected to prolonged exposure to high temperatures, does not produce char or skin, does not gel, and does not exhibit a substantial viscosity change over time.

The hot melt adhesive composition preferably exhibits a peel adhesion failure temperature of greater than 125° F. and a shear adhesion failure temperature of greater than 170° F., or even greater than 190° F.

The ethylene-butene copolymer is random and branched. The ethylene-butene copolymer preferably has a polydispersity index, as measured by molecular weight distribution, Mw/Mn, of greater than 2, greater than 2.5, at least 3, at least 3.5, at least 4, from greater than 2 to about 6, from greater than 2.5 to about 6, or even from about 3.5 to about 6.

The ethylene-butene copolymer has a density greater than 0.850 grams/cubic centimeter (g/cc), greater than 0.860 g/cc, greater than 0.870 g/cc, no greater than 0.950 g/cc, no greater than 0.900 g/cc, no greater than 0.890 g/cc, no greater than 0.885 g/cc, no greater than 0.875, from about 0.850 g/cc to less than 0.950 g/cc, from about 0.860 g/cc to about 0.920 g/cc or even from about 0.880 g/cc to about 0.910 g/cc.

The ethylene-butene copolymer preferably includes ethylene units in an amount of from at least 78 mole percent, at least 80 mole percent, at least 85 mole percent, no greater than 95 mole percent, or even no greater than 90 mole percent, and butene units in an amount of at least 5 mole percent, at least 10 mole percent, at least 15 mole percent, no greater than 22 mole percent, or even no greater than 20 mole percent.

The ethylene-butene copolymer of the hot melt adhesive composition can be in the form of single type of ethylene-butene copolymer or a blend of at least two different ethylene-butene copolymers. The ethylene-butene copolymer preferably has a viscosity of from 2000 centipoise (cps) to 10,000 cps at 350° F. (177° C.), and a melt index of greater than 3 g/10 min, at least 10 g/10 min, at least 20 g/10 min, at least 50 g/10 min, at least 100 g/10 min, at least 200 g/10 min, no greater than 10,000 g/10 min, no greater than 7500 g/10 min, from about 500 g/10 min to about 5000 g/10 min, or even from about 800 g/10 min to about 4000 g/10 min at 190° C. (when tested according to ASTM D1238A).

When the hot melt adhesive composition includes more than one ethylene-butene copolymer, which is referred to herein as a blend of ethylene-butene copolymers, the blend preferably exhibits the viscosity and melt index properties set forth above.

The ethylene-butene copolymer is useful in a variety of applications including, e.g., hot melt adhesive compositions, hot melt pressure sensitive adhesive compositions, films (including, e.g., self-supporting films, i.e., films that do not tear when handled) and combinations thereof. In some embodiments the ethylene-butene copolymer is pressure sensitive, i.e., it is permanently tacky.

The ethylene/butene copolymer can be prepared using any suitable polymerization process including, e.g., batch polymerization processes and continuous polymerization processes. The polymerization process preferably is a high pressure polymerization process. The polymerization process preferably takes place in a high pressure polymerization reactor in which the reaction zone is maintained at a temperature of from about 120° C. to about 355° C. and a pressure of from about 110 MPa to about 350 MPa during the polymerization process. Suitable high pressure reactors include, e.g., tubular high pressure reactors, which typically operate at a temperature of about 120° C. to about 355° C. and a pressure of about 210 MPa to about 310 MPa, and autoclave high pressure reactors, which typically operate at a temperature of about 210° C. to about 310° C. and a pressure of about 110 MPa to about 220 MPa.

In a continuous process, ethylene, butene, and optionally solvent and catalyst are continuously supplied to the reaction zone and the resulting polymer product is continuously removed therefrom. In a batch process the polymer is prepared in a batch, and after polymerization is completed, the polymer is transferred for further processing. Polymerization preferably occurs in the presence of a free radical catalyst or an oxidizing catalyst. The catalyst preferably is free of a single site metallocene catalyst. Useful free radical catalysts include, e.g., any suitable oxidizing chemical, oxygen, di-tert-butyl peroxide, and lauryl peroxide. Other suitable free radical catalysts include any organic or inorganic compound or mixture thereof that generates free radicals. Examples of useful free radical catalyst include per-oxygen type compounds (e.g., hydrogen peroxide, decanoyl peroxide, dialkyl dioxides including, e.g., diethyl peroxide, ditertiary butyl peroxide, butyryl peroxide, t-butyl-peroctoate, di-t-butyl peracetate, lauroyl peroxide, benzoyl peroxide, and t-butyl peracetate, and alkylhydroperoxides), diperoxy dicarbonate esters, tert alkyl percarboxylates (e.g., tert butyl perbenzoate and potassium persulfate), azo-type compounds (e.g., azo-bis (isobutyronitrile)), azines (e.g., benzylazine), oximes (e.g., acetone oxime), alkali metal persulfates, perborates, and percarbonates, and combinations thereof. The free radical catalyst can be employed in the form of a solution or suspension in a solvent (e.g., benzene). Only a small amount of initiator is required. Generally, initiator concentration will vary from about 0.0005% to about 2% of the total weight of material charged to the polymerization reactor. A useful molar ratio of catalyst:polymerizable compounds for a polymerization reaction is from 10⁻¹²:1 to 10⁻¹:1, or even from 10⁻⁹:1 to 10⁻⁵:1.

The feed to the polymerization reactor can also include modifiers (which are also referred to as telogens). Suitable modifiers include, e.g., saturated aliphatic aldehydes (e.g., formaldehyde and acetaldehyde), saturated aliphatic ketones (e.g., acetone, diethyl ketone, and diamyl ketone), saturated aliphatic alcohols (e.g., methanol, ethanol, and propanol), paraffins (e.g., pentane and hexane), cycloparaffins (e.g., cyclohexane), aromatic compounds (e.g., toluene, diethylbenzene, and xylene) and other compounds that function as chain terminating agents (e.g., carbon tetrachloride and chloroform).

The ethylene-butene copolymer is preferably present in the hot melt adhesive composition in an amount of from about 40% by weight to 97% by weight, from about 50% by weight to about 95% by weight, or even from about 55% by weight to about 90% by weight.

Useful tackifying agents for inclusion in the hot melt adhesive composition include, e.g., natural and modified rosin (e.g., gum rosin, wood rosin, tall-oil rosin, distilled rosin, hydrogenated rosin, dimerized rosin and polymerized rosin), glycerol and pentaerythritol esters of natural and modified rosins (e.g., glycerol ester of pale wood rosin, glycerol ester of hydrogenated rosin, glycerol ester of polymerized rosin, pentaerythritol ester of pale wood rosin, pentaerythritol ester of hydrogenated rosin, pentaerythritol ester of tall oil rosin and the phenolic modified pentaerythritol ester of rosin), polyterpene resins having a softening point, as determined by ASTM method E28-58T, of from about 10° C. to 140° C. and hydrogenated polyterpene resins, copolymers and terpolymers of natural terpenes (e.g. styrene-terpene, alpha-methyl styrene-terpene and vinyl toluene-terpene), phenolic-modified terpene resins, aliphatic and cycloaliphatic petroleum hydrocarbon resins having Ring and Ball softening points of from about 10° C. to 140° C. (e.g., branched and unbranched C₅ resins, C₉ resins, and C₁₀ resins), aromatic petroleum hydrocarbons and the hydrogenated derivatives thereof, aliphatic/aromatic petroleum derived hydrocarbons and the hydrogenated derivatives thereof, and combinations thereof. One useful aliphatic hydrocarbon resin is available under the trade designation EASTOTAC H130W from Eastman Chemical Company (Kingsport, Tenn.). The tackifying agent is preferably present in the composition in an amount of no greater than 30% by weight, no greater than 25% by weight, no greater than 20% by weight no greater than 10% by weight, from 5% by weight to 15% by weight, or even from 5% by weight to 10% by weight.

Useful classes of waxes suitable for inclusion in the hot melt adhesive composition include, e.g., paraffin waxes, microcrystalline waxes, high density low molecular weight polyethylene waxes, by-product polyethylene waxes, Fischer-Tropsch waxes, oxidized Fischer-Tropsch waxes, functionalized waxes such as hydroxy stearamide waxes and fatty amide waxes, animal waxes, vegetable waxes and combinations thereof. Useful waxes are solid at room temperature and preferably have a Ring and Ball softening point of from 50° C. to 120° C. Useful low molecular weight polyethylene waxes (i.e., polyethylene having a molecular weight from 500 to 7000) have a hardness value of from about 0.1 to 20, as determined by ASTM D 5 needle and the a 100 g load test, and an ASTM softening point of from about 65° C. to about 125° C. Useful paraffin waxes have a melting point of from about 50° C. to about 80° C. Useful microcrystalline waxes have a melting point of from about 55° C. to 95° C. as determined by ASTM method D127-60. Useful animal and vegetable waxes include hydrogenated animal, fish and vegetable fats and oils including, e.g., hydrogenated tallow, lard, soya oil, cottonseed oil, castor oil, menhadin oil, cod liver oil and combinations thereof that are solid at ambient temperature by virtue of their being hydrogenated. One example of a useful commercially available Fischer-Tropsch wax is BARECO PX100 from Baker Hughes Inc.(Sugar Land, Tex.). Wax is preferably present in the hot melt adhesive composition in an amount of from 0% by weight to about 30% by weight, from about 5% by weight to about 25% by weight, or even from about 5% by weight to about 20% by weight wax.

The composition optionally includes a plasticizer. Useful classes of plasticizers include, e.g., liquid plasticizers, solid plasticizers, and combinations thereof. Suitable plasticizers include, e.g., plasticizing oils (e.g., mineral oil), olefin oligomers, and low molecular weight polymers, vegetable oil, animal oil and derivatives of such oils. Examples of useful olefin oligomers include propylene, polybutene, hydrogenated polyisoprene, and hydrogenated butadiene oligomers, having average molecular weights of from about 350 to about 10,000. Suitable vegetable and animal oils include glycerol esters of the fatty acids and polymerization products thereof. Suitable solid plasticizers include, e.g., BENZOFLEX 352, which is commercially available from Genovique Specialties Corp. (Rosemont, Ill.).

The hot melt adhesive composition optionally includes additional polymer other than the ethylene-butene random copolymer. Examples of useful classes of additional polymers include block copolymers, homopolymers, copolymers, terpolymers and interpolymers of ethylene.

Suitable block copolymers include block copolymers having non-elastomeric end-blocks of styrene and a rubbery mid-block of butadiene, isoprene, ethylene/propylene, ethylene/butylene and combinations thereof. Block copolymers are available in a variety of structures including, e.g., A-B-A triblock structures, A-B diblock structures, (A-B)ₙ radial block copolymer structures, and branched and grafted versions thereof, wherein the A endblock is a non-elastomeric polymer block that includes, e.g., polystyrene, vinyl or a combination thereof, and the B block is an unsaturated conjugated diene or hydrogenated version thereof. Examples of suitable B blocks include isoprene, butadiene, ethylene/butylene (hydrogenated butadiene), ethylene/propylene (hydrogenated isoprene) and combinations thereof.

Examples of suitable homopolymers, copolymers and terpolymers of ethylene include low density polyethylene, grafted and malleated polyethylene, ethylene vinyl acetate copolymers, ethylene n-butyl acrylate copolymers, and ethylene methylacrylate copolymers, homopolymers, copolymers and terpolymers of propylene. Additional polymers may be present in the adhesive composition in amounts of no greater than 20% by weight or even no greater than 10% by weight.

The hot melt adhesive composition optionally includes other additives including, e.g., stabilizers, antioxidants, pigments, dyes, ultraviolet light absorbers, flame retardants, fillers, and combinations thereof. Useful antioxidants include high molecular weight hindered phenols and multifunctional phenols. Useful stabilizers include phosphites, such as tris-(p-nonylphenyl)-phosphite (TNPP) and bis(2,4-di-tert-butylphenyl)4,4′-diphenylene-diphosphonite and di-stearyl-3,3′-thiodipropionate (DSTDP). Useful antioxidants are commercially available under the IRGANOX trade designations, including IRGANOX 1010, IRGANOX 565, and IRGANOX 1076 hindered phenolic antioxidants, and the trade designation IRGAFOS 168 phosphite antioxidant all from Ciba Geigy (Terrytown, N.Y.), under the trade designation BNX, including BXN 1010, from Mayzo, Inc. (Norcross, Ga.), under the trade designation CYANOX LTDP from Cytec Industries (Stamford, Conn.), and under the trade designation ETHANOX 330 from Albemarle Corp. (Baton Rouge, La.). The hot melt adhesive composition can include antioxidant in an amount from about 0% to about 5% by weight, no greater than 2% by weight, or even from about 0.1% to about 2% by weight.

Useful methods of making the hot melt adhesive composition includes continuous processes and batch processes. One useful continuous method of preparing the adhesive composition includes preparing the adhesive in line with the preparation of the ethylene-butene copolymer. In such a process, the ethylene-butene copolymer is fed in line to an adhesive formulation station, e.g., static shear mixer. Additional ingredients are added to the mixer including, e.g., tackifying resin, wax, and other additives, to form the resulting hot melt adhesive composition.

The adhesive composition is useful for a variety of applications including, e.g., packaging (e.g., sealing cases and cartons, and forming trays and boxes), book binding, heat sealing applications, carpet sealing, bag end sealing, bonding filter media, insulation bonding, durable goods manufacturing (e.g., shoes and other athletic gear), wood working, construction, automotive applications and on a variety of substrates including, e.g., cardboard, fiber board, virgin and recycled kraft, high and low density kraft, chipboard and various types of treated and coated kraft and chipboard, and corrugated versions of the same, clay coated chipboard carton stock, and combinations thereof.

The adhesive composition is also suitable for a variety of constructions including, e.g., composites (e.g., composites used in packaging applications including, e.g., packaging alcoholic beverages). Useful composites include, e.g., chipboard laminated to metal foil (e.g., aluminum foil), which is optionally laminated to one or more layers of polymer film including, e.g., polyethylene, mylar, polypropylene, polyvinylidene chloride, and ethylene vinyl acetate film, and multilayer films thereof having a combination of layers of film having the same or different composition. The film is optionally bonded directly to chipboard, kraft and combinations thereof.

The adhesive can be applied to a substrate using any suitable application method including, e.g., direct coating, spray coating (e.g., spiral spray), extrusion (e.g., applying a bead), wheel application, noncontact coating, contacting coating, gravure, roll coating, transfer coating, and combinations thereof.

The invention will now be described by way of the following examples. All parts, ratios, percents and amounts stated in the Examples are by weight unless otherwise specified.

### EXAMPLES

### Test Procedures

Test procedures used in the examples include the following. All ratios and percentages are by weight unless otherwise indicated.

### Density

Density is measured in accordance with ASTM D-792. The samples are annealed at ambient conditions for 24 hours before the measurement is taken. The results are reported in units of g/cc.

### Melt Index

Melt index is measured in accordance with ASTM D-1238 at 190° C. The results are reported in units of g/10 min.

### Polydispersity Index

Polydispersity index is determined according to the formula (Mw/Mn) where Mw is the weight average molecular weight and Mn is the number average molecular weight.

### Viscosity

A. Ethylene-Butene Copolymer

The melt viscosity of the ethylene-butene copolymer is determined in accordance with the following procedure using a Brookfield Laboratories LVDVII+ Thermosel Viscometer in disposable aluminum sample chambers. The spindle used is a SC-27 spindle, suitable for measuring viscosities in the range of from 10 centipoise (cps) to 80,000 cps. A cutting blade is employed to cut samples into pieces small enough to fit into the 1 inch wide, 5 inches long (2.5 cm wide, 13 cm long) sample chamber. A 10 gram sample of the copolymer is placed in the chamber, which is in turn inserted into a Brookfield Thermosel and locked into place with bent needle-nose pliers. The sample chamber has a notch on the bottom that fits the bottom of the Brookfield Thermosel to ensure that the chamber is not allowed to turn when the spindle is inserted and spinning. The sample is heated to 350° F. (177° C.), with additional sample being added until the melted sample is about 1 inch (2.5 cm) below the top of the sample chamber. The viscometer apparatus is lowered and the spindle submerged into the sample chamber. Lowering is continued until brackets on the viscometer align on the Thermosel. The viscometer is turned on, and set to a speed that, when taken in combination with the spindle number, leads to a torque reading of from 30% to 60% of the range, as reflected on the display of the viscometer. Readings are taken every minute for about 15 minutes, or until the values stabilize, which final reading is recorded in units of centipoise (cps).

B. Hot Melt Adhesive Composition

The melt viscosity of the hot melt adhesive composition is determined according the viscosity method set forth above with respect to the ethylene-butene copolymer with the exception that a Brookfield Thermosel Viscometer Model LVDVII+ and a number 21 spindle are used. The results are reported in units of cps.

### Peel Adhesion Failure Temperature to Kraft Test Method

Peel adhesion failure temperature (PAFT) is determined as follows. A sample is prepared by coating the sample composition onto kraft paper by hand using a glass rod or shim to achieve a coating that is one inch (2.5 cm) wide and from 8 mils to 10 mils (i.e., from 0.008 inches to 0.010 inches, from 2.0 cm to 2.5 cm) thick. A second sheet of kraft paper is applied to the sample composition and pressed against the same. The sample is positioned in an oven in the peel mode such that a first sheet of kraft of the sample is held in position in the oven by a clamp, and a 100 gram weight is attached to the top edge of the second sheet of kraft. The ambient temperature in the oven is ramped from a starting temperature of 25° C. to an ending temperature of 100° C. at a rate of 25° C./hour. The oven automatically records the temperature at which the samples fail. A minimum of eight samples are run for each sample composition.

### Shear Adhesion Failure Temperature to Kraft Test Method

Shear adhesion failure temperature (SAFT) is determined as follows. A sample is prepared by coating an adhesive composition onto kraft paper by hand using a glass rod or shim to achieve a coating that is one inch (2.5 cm) wide and from 8 mils to 10 mils (i.e., from 0.008 inches to 0.010 inches, from 2.0 cm to 2.5 cm) thick. A second sheet of kraft paper is applied to the sample composition and pressed against the same. The resulting sample is then positioned in an oven in the shear mode such that the first sheet of the sample is held in position in the oven by a clamp, and a 500 gram weight is suspended from each sample in the shear mode, i.e., the weight is attached to the lower edge of the second sheet of kraft. The ambient temperature in the oven is ramped from a starting temperature of 25° C. to an ending temperature of 100° C. at a rate of 25° C./hour. The oven automatically records the temperature at which the samples fail. A minimum of eight samples are run for each sample composition.

### Fiber Tear Test Method

Fiber tear measures the percentage of fiber that covers the area of an adhesive after two substrates, which have been previously bonded together through the adhesive, are separated by force. The percentage of fiber tear is determined as follows. A bead of adhesive composition measuring 15.24 cm (6 inch)×0.24 cm ( 3/32 inch) is applied to a first substrate of Inland high performance 57 pound 100% virgin liner board, using a Waldorf bond simulator at the specified application temperature. Two seconds after the bead of adhesive is applied to the first substrate, the bead of adhesive is contacted with a second substrate of Inland high performance 57 pound 100% virgin liner board, which is pressed against the adhesive and the first substrate with a pressure of 0.21 Mpa (30 pounds per square inch (psi)) for a period of 2 seconds.

The resulting construction is then conditioned at the specified test temperature for at least 24 hours, and then the substrates of the construction are separated from one another by pulling the two substrates apart from one another by hand. The surface of the adhesive composition is observed and the percent of the surface area of the adhesive composition that is covered by fibers is determined and recorded. A minimum of six samples are prepared and tested for each hot melt adhesive composition.

### Heat Stability Test Method

Heat stability tests are conducted as follows. A 260 gram sample of each the adhesive is placed in a glass beaker, which is then placed in a forced air oven at 350° F. (177° C.), and allowed to sit in the oven for 200 hours. A small portion of the adhesive, i.e., from about 10 gram to about 20 gram, is removed from the beaker at 96 hours and 200 hours. The viscosity and Molten Gardner Colors are determined at each time interval according to ASTM D 4499-95 Standard Test Method for Heat Stability of Hot-Melt Adhesives (1995). The change in viscosity is reported as a percentage and the change in Molten Gardner Color is reported in Gardner Color units.

### Example 1

Ethylene and butene gases are introduced into a polymerization reactor of a commercial large-scale polyethylene manufacturing system. The mixture is polymerized in the reactor under heat and pressure at a temperature of from about 120° C. to about 355° C. and a pressure of from about 110 MPa to about 350 MPa and in the presence of a free radical catalyst to form an ethylene-butene copolymer.

### Example 2

The ethylene-butene copolymer prepared in Example 1 is discharged from the reactor in the form of a molten liquid and fed into an accumulator bin that is in line with the reactor. The ethylene-butene copolymer is then transported to a static shear mixer where tackifying agent, wax, and antioxidant are added to the composition. The composition is heated while being subjected to shear mixing to form a hot melt adhesive composition.

All references cited herein are incorporated herein in their entirety.

Other embodiments are within the claims. Although the adhesive composition has been described as a hot melt adhesive composition, it can also be formulated to be a hot melt pressure sensitive adhesive composition, i.e., a permanently tacky hot melt adhesive composition.

What is claimed is:

1. A hot melt adhesive composition comprising:
ethylene-butene copolymer prepared from ethylene monomer and butene monomer, the ethylene-butene copolymer having a polydispersity index of from 2 to 6 and comprising
at least 78 mole % ethylene, and
no greater than 22 mole % butene.

2. The hot melt adhesive composition of claim 1 comprising from 40% by weight to 90% by weight of the ethylene-butene copolymer, and further comprising
from 5% by weight to 30% by weight tackifying agent;
from 0% by weight to 20% by weight wax; and
from 0% by weight to 5% by weight antioxidant.

3. The hot melt adhesive composition of claim 1, wherein the adhesive composition exhibits a fiber tearing bond when tested according to the Fiber Tear test method.

4. The hot melt adhesive composition of claim 1, wherein the ethylene-butene copolymer is prepared in the absence of a single site metallocene catalyst.

5. A method of bonding a first substrate to a second substrate, the method comprising:
applying the hot melt adhesive composition of claim 1, having a temperature no greater than 120° C., to the first substrate; and
contacting the applied hot melt adhesive composition with a second substrate.

6. The method of claim 5, wherein at least one of the first substrate and the second substrate comprises cellulose fiber.

7. A method of making an adhesive composition, said method comprising:
preparing an ethylene-butene copolymer having a polydispersity index of from 2 to 6 and comprising at least 78 mole % ethylene, and no greater than 22 mole % butene;
transferring the copolymer to a mixer; and
combining at least one of tackifying agent, wax, and antioxidant with the copolymer.

8. The method of claim 7 further comprising forming the adhesive composition, the forming comprising at least one of pelletizing, pillowing, stranding, and pastillating.

9. The method of claim 7, wherein the ethylene-copolymer is in the form of a liquid during the transferring.

10. A method of making an ethylene-butene copolymer, the method comprising:
polymerizing ethylene monomer and butene monomer to form an ethylene-butene copolymer having a polydispersity index of from 2 to 6, the ethylene-butene copolymer comprising at least 78 mole % ethylene and no greater than 22 mole % butene.

11. The method of claim 10, wherein the polymerizing occurs in a reaction zone having a temperature of from about 120° C. to about 355° C. and a pressure of from about 110 MPa to about 350 MPa.

12. The method of claim 10, wherein the polymerizing occurs in the presence of a peroxide catalyst.

13. The method of claim 10, wherein the polymerizing occurs in the absence of a single site metallocene catalyst.

14. A method of making an adhesive composition, said method comprising:
transferring an ethylene-butene copolymer in the form of a liquid to a mixer, the ethylene-butene copolymer having a polydispersity index of from 2 to 6 and comprising at least 78 mole % ethylene, and no greater than 22 mole % butene; and
adding at least one of tackifying agent, wax, and antioxidant to the copolymer.
